(19) United States
(12) Patent Application Publication
(10) Pub. No.: US 2026/0170456 A1
(43) Pub. Date: Jun. 18, 2026

(54) METHOD FOR POSITIONING EMPTY CONTAINER AND RELATED PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventors: JIANKUN HOU, Jiangsu (CN); SHENGFENG PENG, Jiangsu (CN); XINGGUO MA, Jiangsu (CN)

(21) Appl. No.: 19/268,030

(22) Filed: Jul. 14, 2025

(30) Foreign Application Priority Data
Dec. 18, 2024 (CN) 202411874199.0

(51) Int. Cl. G06Q 10/087; G06T 7/73; G06V 10/82

(52) U.S. Cl. CPC G06Q 10/0877; G06T 7/73; G06V 10/82; G06T 2207/20084

(57) ABSTRACT

A method for positioning an empty container includes acquiring worker positioning information and a storage area image of loading containers, identifying an empty container attribute set in the storage area image, determining, based on the storage area image, a container classification label corresponding to each loading container and container position information corresponding to each loading container, and determining a target empty container based on the empty container attribute set, the container classification label corresponding to each loading container, the container position information corresponding to each loading container and the worker positioning information.

### CROSS REFERENCE TO RELATED APPLICATION AND CLAIM OF PRIORITY

This application claims the benefit under 35 USC § 119 of Chinese Patent Application No. 202411874199.0 filed on Dec. 18, 2024, in the Chinese Intellectual Property Office, the entire disclosure of which is incorporated herein by reference for all purposes.

### BACKGROUND

### 1. Technical Field

The present application generally relates to the technical field of logistics management. More specifically, the present application relates to a method for positioning an empty container and related products thereof.

### 2. Background Art

In modern supply chain management, logistics and manufacturing environments, the requirements for boxes are particularly stringent for organization, management and transport of various materials. Various types of boxes are usually stored and used in a factory building to satisfy the loading requirements of different materials. In such an environment, finding an empty box of a desired type in time is critical to improving the production efficiency and the management level.

Current management of empty boxes in a factory building mainly depends on manual operation, and workers complete related tasks by observing with naked eyes and manually carrying the empty boxes. However, due to the unsmooth information transfer in the complex factory environment, the communication between workers is high in cost and involves great manpower consumption and time waste, which is not only low in efficiency, but also easy to cause errors and affect the operation efficiency of the whole supply chain. Although some factory buildings have begun to use technologies such as bar codes and RFID to assist in box management, these technologies all depend on manual scanning and registration, which not only increases the workload of the worker, but also tends to cause problems like identification errors, equipment faults and the like, and thus is hard to satisfy the requirements of efficient and precise management.

In view of this, there is an urgent need to provide a method for positioning an empty container which can enable identification and positioning of an empty container in a factory building, reduce the communication cost and intensity of labor for the worker, increase the operation efficiency of the supply chain, and improve the high-efficient and precise management level of the supply chain.

### SUMMARY

To address at least one or more of the above technical problems, the present application proposes, in various aspects, a method for positioning an empty container and related products thereof. This method for positioning an empty container can enable identification and positioning of an empty container in a factory building, reduce the communication cost and intensity of labor for the worker, increase the operation efficiency of the supply chain, and improve the high-efficient and precise management level of the supply chain.

In a first aspect, the present application provides a method for positioning an empty container, including: acquiring worker positioning information and a storage area image of loading containers; identifying an empty container attribute set in the storage area image; determining, based on the storage area image, a container classification label corresponding to each loading container and container position information corresponding to each loading container; and determining a target empty container based on the empty container attribute set, the container classification label corresponding to each loading container, the container position information corresponding to each loading container and the worker positioning information.

In some embodiments, determining the target empty container based on the empty container attribute set, the container classification label corresponding to each loading container, the container position information corresponding to each loading container and the worker positioning information includes: determining each candidate empty container based on the empty container attribute set and the container classification label corresponding to each loading container; determining a candidate container position corresponding to each candidate empty container based on the container position information corresponding to each loading container; and determining the target empty container based on the candidate container position corresponding to each candidate empty container and the worker positioning information.

In some embodiments, determining each candidate empty container based on the empty container attribute set and the container classification label corresponding to each loading container includes: if the container classification label of a current loading container matches an empty container attribute element in the empty container attribute set, determining that the current loading container is the candidate empty container.

In some embodiments, determining the target empty container based on the candidate container position corresponding to each candidate empty container and the worker positioning information includes: determining, based on the candidate container position corresponding to each candidate empty container and the worker positioning information, each movement trajectory between a worker and each candidate empty container; and determining the target empty container based on a moving distance of each movement trajectory.

In some embodiments, identifying the empty container attribute set in the storage area image includes: identifying an empty container attribute set in the storage area image by an attribute identification model.

In some embodiments, the attribute identification model includes a backbone identification network and an attribute classifier, wherein identifying the empty container attribute set in the storage area image by the attribute identification model includes: performing feature extraction on the storage area image through the backbone identification network to obtain loading container attribute features; and performing feature classification on the loading container attribute features through the attribute classifier to obtain the empty container attribute set.

In some embodiments, determining the container classification label corresponding to each loading container and container position information corresponding to each loading container based on the storage area image includes: determining a container classification label corresponding to each loading container and container position information corresponding to each loading container by a container detection model.

In some embodiments, after determining the target empty container based on the empty container attribute set, the container classification label corresponding to each loading container, the container position information corresponding to each loading container and the worker positioning information, the method further includes: sending the container position information of the target empty container and a movement trajectory corresponding to the target empty container to a worker task terminal.

In a second aspect, the present application provides a device for positioning an empty container, including: a memory; and at least one processor configured to: acquire worker positioning information and a storage area image of loading containers; identify an empty container attribute set in the storage area image; determine, based on the storage area image, a container classification label corresponding to each loading container and container position information corresponding to each loading container; and determine a target empty container based on the empty container attribute set, the container classification label corresponding to each loading container, the container position information corresponding to each loading container and the worker positioning information.

In a third aspect, the present application provides a non-transitory machine-readable medium having a program code for positioning an empty container stored thereon which, when executed by at least one processor, directs the at least one processor to perform the operations of: acquiring worker positioning information and a storage area image of loading containers; identifying an empty container attribute set in the storage area image; determining, based on the storage area image, a container classification label corresponding to each loading container and container position information corresponding to each loading container; and determining a target empty container based on the empty container attribute set, the container classification label corresponding to each loading container, the container position information corresponding to each loading container and the worker positioning information.

The technical solutions provided in the present application may achieve the following beneficial effects:

According to the method for positioning an empty container and the related products thereof provided in the present application, worker positioning information and a storage area image of loading containers are acquired, and then an empty container attribute set in the storage area image is identified, so as to determine which attributes of empty containers are present in the storage area image. Further, based on the storage area image, a container classification label corresponding to each loading container and container position information corresponding to each loading container are determined, and then a target empty container is determined based on the empty container attribute set, the container classification label corresponding to each loading container, the container position information corresponding to each loading container and the worker positioning information. Therefore, each desired empty container can be accurately screened out through the container classification label corresponding to each loading container and the empty container attribute set, thereby implementing automatic, real-time and precise detection and positioning of the empty container, and an empty container closest to a worker can be determined by the container position information corresponding to each loading container and the worker positioning information, which can help to reduce the communication cost and intensity of labor for the worker and improve the working efficiency of the worker.

Generally speaking, the present application can enable identification and positioning of an empty container in a factory building, reduce the communication cost and intensity of labor for the worker, increase the operation efficiency of the supply chain, and improve the high-efficient and precise management level of the supply chain.

### BRIEF DESCRIPTION OF THE DRAWINGS

The above and other objectives, features and advantages of exemplary implementations of the present application will become readily apparent from the following detailed description, which proceeds with reference to the accompanying drawings. In the accompanying drawings, several implementations of the present application are illustrated by way of example but not limitation, and like or corresponding reference numerals indicate like or corresponding parts, in which:

FIG. 1 shows an exemplary flowchart of a method for positioning an empty container according to some embodiments of the present application;

FIG. 2 shows an exemplary flowchart of a method for positioning an empty container according to some other embodiments of the present application;

FIG. 3 shows an exemplary flowchart of a method for positioning an empty container according to still other embodiments of the present application; and

FIG. 4 shows a block diagram of hardware configuration of a device for positioning an empty container that can implement the method for positioning an empty container according to an embodiment of the present application.

### DETAILED DESCRIPTION

The technical solutions in the embodiments of the present application will be clearly and completely described below with reference to the accompanying drawings in the embodiments of the present application. Apparently, the described embodiments are only part, but not all, of the embodiments of the present application. For simplicity and clarity of illustration, where considered appropriate, reference numerals may be repeated among the figures to indicate corresponding or analogous elements. In addition, the present application sets forth numerous specific details to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Moreover, the description should not be taken as limiting the scope of the embodiments described herein. All other embodiments obtained by a person skilled in the art based on the embodiments in the present application without making any creative effort belong to the protection scope of the present application.

It should be understood that the possible terms “first” or “second” or the like in the claims, description and drawings disclosed in the present application are used to distinguish different objects, and are not used to describe a particular order. The terms “comprise” and “include”, when used in the description and claims of the present application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the present application herein is for the purpose of describing particular embodiments only, and is not intended to limit the present application. As used in the specification and claims of the present application, the singular forms “a”, “an” and “the” are intended to include the plural forms as well, unless the context clearly indicates otherwise. It should be further understood that the term “ and/or” as used in the description and claims of the present application refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

Due to the unsmooth information transfer in the complex factory environment, the communication between workers is high in cost and involves great manpower consumption and time waste, which is not only low in efficiency, but also easy to cause errors and affect the operation efficiency of the whole supply chain. Although some factory buildings have begun to use technologies such as bar codes and RFID to assist in box management, these technologies all depend on manual scanning and registration, which not only increases the workload of the worker, but also tends to cause problems like identification errors, equipment faults and the like, and thus is hard to satisfy the requirements of efficient and precise management.

In view of this, there is an urgent need to provide a method for positioning an empty container which can enable identification and positioning of an empty container in a factory building, reduce the communication cost and intensity of labor for the worker, increase the operation efficiency of the supply chain, and improve the high-efficient and precise management level of the supply chain.

Specific implementations of the present application will be described in detail below with reference to the accompanying drawings.

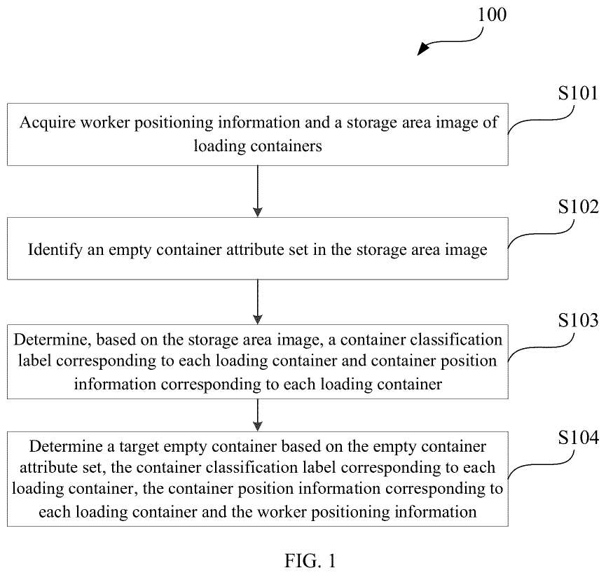

FIG. 1 shows an exemplary flowchart 100 of a method for positioning an empty container according to some embodiments of the present application. Referring to FIG. 1, a method for positioning an empty container according to an embodiment of the present application may include the following steps S101 to S104:

At step S101, worker positioning information and a storage area image of loading containers are acquired. In the embodiment of the present application, the worker positioning information refers to positioning information of a worker loading a cargo in a factory building, which may be manually input into a worker task terminal by the worker, or may be acquired through automatic positioning by the worker task terminal, so that the system can receive the worker positioning information sent from the worker task terminal. The worker task terminal is a terminal for distributing a cargo loading task to a worker, which may be a mobile terminal such as a mobile phone or a tablet. In practical applications, the worker task terminal may be in various forms, and the specific form of the worker task terminal may be determined in practical applications according to the practical application conditions, which is not limited in any manner in the present application.

In another aspect, the loading container refers to a container for loading a cargo in a factory building, which may be a box, a trailer compartment, a barrel, or the like. The specific form of the loading container may be determined according to the practical application conditions, which is not limited in any manner in the present application. Further, the storage area image of loading containers may be acquired by one or more high-definition cameras arranged in the factory building, where imaging fields of view of the high-definition cameras cover the whole area storing the loading containers, so that the storage area image of loading containers can be acquired in real time.

At step S102, an empty container attribute set in the storage area image is identified. In the embodiment of the present application, the empty container attribute set refers to a set composed of one or more empty container attribute elements, where each empty container attribute element may be used to describe an attribute feature, such as an appearance feature or a model feature, of an empty container. For example, if there is a yellow medium empty container and a blue large empty container in the current storage area image, then the empty container attribute set contains two attribute elements, i.e., “yellow medium empty” and “blue large empty”. It will be understood that the specific form of the attribute feature such as an appearance feature or a model feature of the empty container may vary and determined according to the practical application conditions in practical applications, which is not limited in any manner in the present application.

At step S103, based on the storage area image, a container classification label corresponding to each loading container and container position information corresponding to each loading container are determined. In an embodiment of the present application, a container classification label corresponding to each loading container and container position information corresponding to each loading container may be further determined in the storage area image. Illustratively, the corresponding container classification label and the corresponding container position information may be marked on a detection box of each loading container. The container classification label may be used to describe an attribute feature, such as an appearance feature or a model feature, of a loading container. Illustratively, if a current loading container is a yellow medium full container, then the container classification label marked on the corresponding detection box is “yellow medium full”. In addition, the container position information may be coordinate positioning information of a loading container.

At step S104, a target empty container is determined based on the empty container attribute set, the container classification label corresponding to each loading container, the container position information corresponding to each loading container and the worker positioning information. In the embodiment of the present application, empty containers with consistent attributes may be firstly screened out through the empty container attribute set and the container classification label corresponding to each loading container, so that accurate detection of the empty containers is guaranteed. It will be understood that, in further combination with a cargo loading amount of a current loading task, one or more candidate empty containers for the current loading task may be found from the screened empty containers. Illustratively, for example, when the cargo loading amount is greater than a first loading amount threshold, all the blue large empty containers in the storage area image may be screened out; and when the cargo loading amount is between the first loading amount threshold and a second loading amount threshold (the second loading amount threshold is smaller than the first loading amount threshold and greater than zero), all the yellow medium empty containers in the storage area image may be screened out.

Furthermore, when all the one or more candidate empty containers satisfying the current loading task in the storage area image are screened out, a target empty container which is most convenient for a worker to fetch may be selected based on the container position information corresponding to each loading container and the worker positioning information, which can help to reduce the workload of the worker and improve the working efficiency of the worker.

According to the embodiments of the present application, worker positioning information and a storage area image of loading containers are acquired, and then an empty container attribute set in the storage area image is identified, so as to determine which attributes of empty containers are present in the storage area image. Further, based on the storage area image, a container classification label corresponding to each loading container and container position information corresponding to each loading container are determined, and then a target empty container is determined based on the empty container attribute set, the container classification label corresponding to each loading container, the container position information corresponding to each loading container and the worker positioning information. Therefore, each desired empty container can be accurately screened out through the container classification label corresponding to each loading container and the empty container attribute set, thereby implementing automatic, real-time and precise detection and positioning of the empty container, and an empty container closest to a worker can be determined by the container position information corresponding to each loading container and the worker positioning information, which can help to reduce the communication cost and intensity of labor for the worker and improve the working efficiency of the worker. Generally speaking, the present application can enable identification and positioning of an empty container in a factory building, reduce the communication cost and intensity of labor for the worker, increase the operation efficiency of the supply chain, and improve the high-efficient and precise management level of the supply chain.

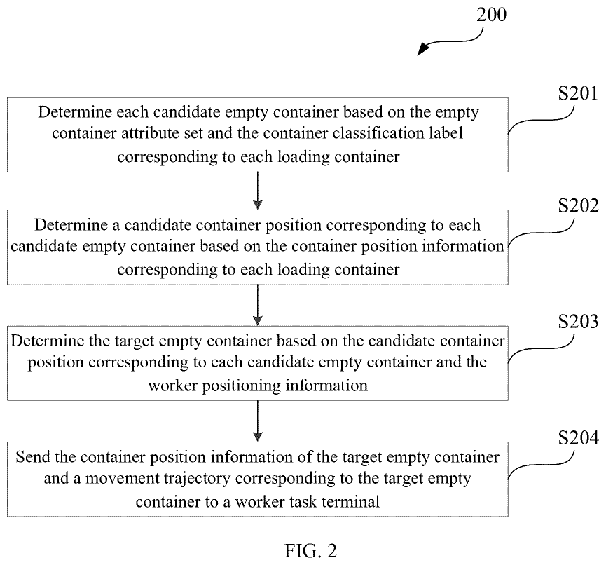

In some embodiments, the process of determining the target empty container may be further designed. The process of determining the target empty container will be described in detail below in conjunction with FIG. 2. FIG. 2 shows an exemplary flowchart 200 of a method for positioning an empty container according to some other embodiments of the present application. Referring to FIG. 2, a method for positioning an empty container according to an embodiment of the present application may include the following steps S201 to S204:

At step S201, each candidate empty container is determined based on the empty container attribute set and the container classification label corresponding to each loading container. In an embodiment of the present application, if the container classification label of a current loading container matches an empty container attribute element in the empty container attribute set, for example, the container classification label of a current loading container is “yellow medium empty”, while the empty container attribute set also contains an empty container attribute element “yellow medium empty”, it indicates that the same empty container attribute appears in both the identification process of the empty container attribute set and the detection and determination process of the container classification label corresponding to each loading container, so that an empty container with that attribute in the storage area image is accurately determined, thereby determining that the current loading container is the candidate empty container and improving the detection accuracy of the candidate empty container.

At step S202, a candidate container position corresponding to each candidate empty container is determined based on the container position information corresponding to each loading container. In an embodiment of the present application, since the candidate empty containers are included in the loading containers, the position information may be determined for each candidate empty container based on the container position information corresponding to each loading container, so that the candidate container position corresponding to each candidate empty container can be determined.

At step S203, the target empty container is determined based on the candidate container position corresponding to each candidate empty container and the worker positioning information. In an embodiment of the present application, each movement trajectory between a worker and each candidate empty container may be determined based on the candidate container position corresponding to each candidate empty container and the worker positioning information, so that a moving distance of the worker to reach each candidate empty container along each movement trajectory can be further determined, and then the target empty container can be determined based on the moving distance of each movement trajectory. For example, a candidate empty container corresponding to a movement trajectory having the shortest moving distance may be selected as the target empty container. It will be understood that, in practical applications, other factors may be further considered in addition to the moving distance to jointly determine the target empty container. For example, if the worker needs to fetch another object for loading on the way, a movement trajectory which is short in moving distance while enabling the worker to fetch the object on the way may be selected, and then, a candidate empty container corresponding to that movement trajectory is determined as the target empty container. More or fewer factors may be considered to determine the target empty container according to the practical application conditions in practical applications, which is not limited in any manner in the present application. Therefore, the workload of the worker can be reduced, and the working efficiency of the worker can be improved.

At step S204, the container position information of the target empty container and a movement trajectory corresponding to the target empty container are sent to a worker task terminal. It will be understood that, by the worker task terminal, the worker can conveniently check the movement trajectory and reach the positioned target empty container along the movement trajectory, thereby reducing the communication cost for the worker. It will be further understood that in a next loading task of the worker, the target empty container will also dynamically change with the worker position and the loading amount, so that the worker can reach the positioned next target empty container.

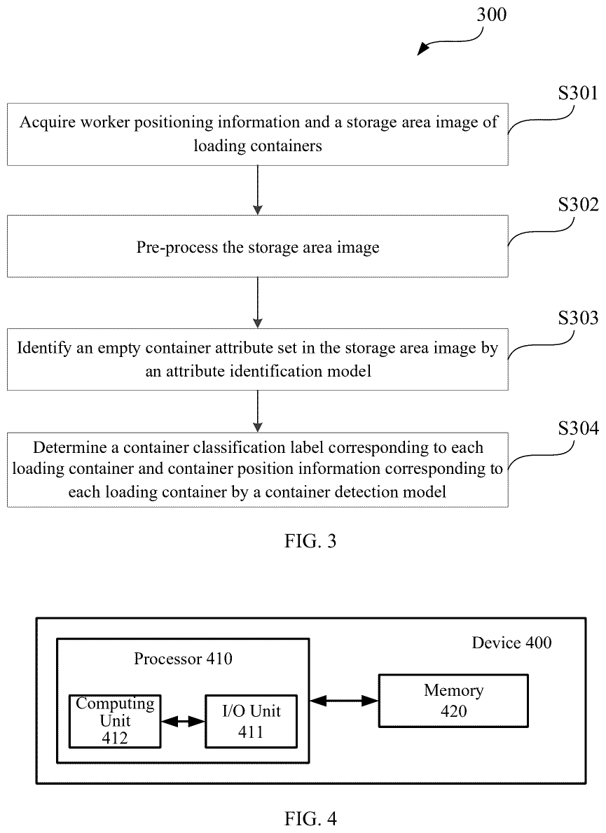

In some embodiments, after the storage area image is acquired, the storage area image may be pre-processed to improve the accuracy of subsequent identification and detection. The pre-processing process of the storage area image, the identification process of the empty container attribute set, the detection and identification process of the container classification label corresponding to each loading container and the container position information corresponding to each loading container will be described in detail below with reference to FIG. 3. FIG. 3 shows an exemplary flowchart 300 of a method for positioning an empty container according to still other embodiments of the present application. Referring to FIG. 3, a method for positioning an empty container according to an embodiment of the present application may include the following steps S301 to S304:

At step S301, worker positioning information and a storage area image of loading containers are acquired. In the embodiment of the present application, the content of step S301 is substantially the same as the content of step S101, and thus is not repeated here.

At step S302, the storage area image is pre-processed. In an embodiment of the present application, the acquired storage area image is subjected to pre-processing including, but not limited to, image denoising, image enhancement, image cutting and the like, so that the accuracy and processing efficiency of subsequent identification and detection can be improved.

At step S303, an empty container attribute set in the storage area image is identified by an attribute identification model. In an embodiment of the present application, the attribute identification model includes a backbone identification network and an attribute classifier. The backbone identification network may adopt ResNeSt50, which is an improved convolutional neural network model belonging to the ResNeSt family which is a highly modular image classification network architecture that enhances the expressive power of features by introducing an attention mechanism. The ResNeSt50 includes 50 layers, and a main structure including: a convolutional layer for extracting low-level features in the image such as edges and corners; a pooling layer for reducing a feature map size to reduce computational complexity and enhance model translational invariance; a residual module for allowing a gradient to be directly passed from a following convolutional layer to a preceding convolutional layer by skip connections; and a split-attention module for automatically assigning more attention to more important features according to weights of different features. The ResNeSt50 is designed to enable the network to better learn feature identifiers in the image, so that the ResNeSt50 may be used as a backbone identification network to perform feature extraction on the storage area image to obtain loading container attribute features.

Further, the structure of the attribute classifier may include an average pooling layer, a linear layer (also called a fully connected layer or a dense layer), and a BatchNorm (BN) layer. After the loading container attribute features are input into the attribute classifier, feature classification is performed on the loading container attribute features through the attribute classifier to obtain N types of attribute feature classification results, where N is a positive integer. Further, each classification result satisfying the empty feature in the N types of attribute feature classification results is determined as an empty container attribute element, and various empty container attribute elements form the empty container attribute set. Illustratively, if 4 types of attribute feature classification results are obtained by the attribute classifier, which are specifically yellow medium empty, yellow medium full, blue large empty, and blue large full, then the empty container attribute elements in the empty container attribute set are yellow medium empty and blue large empty.

In an embodiment of the present application, to guarantee accurate detection of the empty container, before the subsequent detection by the container detection model, identification by the attribute identification model is firstly performed to judge whether the storage area image includes an empty container with certain attribute(s), and actual position detection of the identified empty container is not needed in the identification process by the attribute identification model. It is advantageous to perform subsequent detection of the desired empty container under the condition of determining that the storage area image includes an empty container with certain attribute(s).

To implement the identification function of the attribute identification model, a plurality of images containing loading containers may be captured in a training process of the attribute identification model, and used as a training image set for the attribute identification model. In practical application scenarios, the loading containers may be arranged in a stack, so that instead of labelling each loading container, the stack of loading containers may be labelled collectively in the embodiment of the present application, because only whether there is a loading container with a certain attribute in the image, rather than the specific position of each loading container, is desired to be labelled in the training data of the attribute identification model. Therefore, the labelling efficiency of the training image set can be improved. Illustratively, if there are 4 types of attribute feature classification results to be identified now, which are labelled as “yellow medium empty, yellow medium full, blue large empty, and blue large full” in sequence, when there are only yellow medium empty containers in the training image, the training image may be then labelled as “1-0-0-0”; and when there are yellow medium full and blue large empty containers in the training image, the training image may be then labelled as “0-1-1-0”. It will be understood that the training image set may be labelled in various manners, and the labelling manner may be determined according to the practical application conditions, which is not limited in any manner in the present application.

When the data labelling is completed, the labelled training image set may be input into the initial attribute identification model and iterated constantly. Illustratively, a cross entropy loss function may be used to determine whether the training of the attribute identification model is completed, and the attribute identification model is output if the training is completed.

At step S304, a container classification label corresponding to each loading container and container position information corresponding to each loading container are determined by a container detection model. In an embodiment of the present application, the container detection model may adopt YOLOv8, where a cross stage partial network (CSPNet) may be adopted as a backbone detection network; a path aggregation network (PANet) may be adopted as a feature fusion layer; a de-coupled head structure may be adopted as an output layer that separates classification and detection; and a binary cross-entropy loss function may be adopted as a classification loss function, while a distribution focal loss+complete IoU loss function may be adopted as a regression loss function. In terms of label matching, a Task-Aligned Assigner positive and negative sample assignment policy may be employed.

To implement the detection function of the container detection model for each loading container, a plurality of images containing the loading container may be captured in a training process of the container detection model, and used as a training data set for the container detection model. In the process of data labelling of the training data set, the data labelling may be performed according to the labelling requirement of YOLOv8. That is, a detection box for each type of loading container is labelled in each training image of the training data set. Illustratively, if there are 4 types of attribute feature classification results to be identified now, which are “yellow medium empty, yellow medium full, blue large empty, and blue large full” respectively, then corresponding circumscribed detection boxes are created for each yellow medium empty container, each yellow medium full container, each blue large empty container, and each blue large full container, respectively. When the data labelling is completed, the labelled training data set may be input into the initial container detection model and iterated constantly, so that the loss function value is reduced but does not overfit, and finally a trained container detection model is output. The trained container detection model is capable of detecting each loading container and identifying the container classification label and container position information for each loading container detected.

It will be understood that in the embodiment of the present application, only if the same empty container attribute is output in both the empty container attribute set and the container classification label corresponding to each loading container, it can be determined that an empty container corresponding to the empty container attribute is present in the storage area image, thereby guaranteeing accurate detection of the empty container.

Corresponding to the embodiments of the application function implementation method described above, the present application further provides a device for positioning an empty container and corresponding embodiments thereof.

FIG. 4 shows a block diagram of hardware configuration of a device 400 for positioning an empty container that can implement the method for positioning an empty container according to an embodiment of the present application. As shown in FIG. 4, the device 400 for positioning an empty container may include a processor 410 and a memory 420. In the device 400 for positioning an empty container of FIG. 4, only constituent elements related to the present embodiment are shown. Therefore, it will be apparent to those of ordinary skill in the art that: the device 400 for positioning an empty container may further include common constituent elements other than those shown in FIG. 4, such as a fixed-point arithmetic unit.

The device 400 for positioning an empty container may correspond to a computing device having various processing functions, such as functions for generation, training or learning of a neural network, for quantizing a floating point type neural network to a fixed point type neural network, or for retraining a neural network. For example, the device 400 for positioning an empty container may be implemented by various types of devices, such as a personal computer (PC), a server device, a mobile device, and so on.

The processor 410 controls all functions of the device 400 for positioning an empty container. For example, the processor 410 controls all functions of the device 400 for positioning an empty container by executing programs stored on the memory 420 in the device 400 for positioning an empty container. The processor 410 may be implemented by a central processing unit (CPU), a graphics processing unit (GPU), an application processor (AP), an intelligent processing unit (IPU), and the like provided in the device 400 for positioning an empty container. However, the present application is not limited thereto.

In some embodiments, the processor 410 may include an input/output (I/O) unit 411 and a computing unit 412. The I/O unit 411 may be configured to receive various types of data, such as worker positioning information and a storage area image of loading containers. Illustratively, the computing unit 412 may be configured to identify an empty container attribute set in the storage area image received by the I/O unit 411; further determine a container classification label corresponding to each loading container and container position information corresponding to each loading container based on the storage area image; and determine a target empty container based on the empty container attribute set, the container classification label corresponding to each loading container, the container position information corresponding to each loading container and the worker positioning information. This target empty container may be output by, for example, the I/O unit 411. The output data may be provided to the memory 420 for reading by other devices (not shown), or may be provided directly to other devices for use.

The memory 420 is hardware for storing various types of data processed in the device 400 for positioning an empty container. For example, the memory 420 may store processed data and data to be processed in the device 400 for positioning an empty container. The memory 420 may store data sets processed or to be processed by the processor 410 involved in steps of the method for positioning an empty container, such as worker positioning information and a storage area image of loading containers and the like. Further, the memory 420 may store applications to be driven by the device 400 for positioning an empty container, drivers, and the like. For example: the memory 420 may store various programs related to a method for positioning an empty container to be executed by the processor 410. The memory 420 may be a DRAM, but the present application is not limited thereto. The memory 420 may include at least one of a volatile memory or a non-volatile memory. The non-volatile memory may include a read-only memory (ROM), a programmable ROM (PROM), an electrically programmable ROM (EPROM), an electrically erasable programmable ROM (EEPROM), a flash, phase-change RAM (PRAM), a magnetic RAM (MRAM), a resistive RAM (RRAM), a ferroelectric RAM (FRAM), or the like. The volatile memory may include a dynamic RAM (DRAM), a static RAM (SRAM), a synchronous DRAM (SDRAM), a PRAM, an MRAM, an RRAM, a ferroelectric RAM (FeRAM), or the like. In one embodiment, the memory 420 may include at least one of a hard disk drive (HDD), a solid state drive (SSD), a compact flash (CF), a secure digital (SD) card, a Micro-SD card, a Mini-SD card, an xD card, a cache, or a memory stick.

In summary, specific functions implemented by the memory 420 and the processor 410 of the device 400 for positioning an empty container provided in the implementations of the present disclosure may be explained in comparison with the foregoing implementations in the description of the present disclosure, and can achieve the technical effects of the foregoing implementations, and therefore, no further description is provided herein.

In this implementation, the processor 410 may be implemented in any suitable manner. For example, the processor 410 may take the form of, for example, a microprocessor or processor, and a computer-readable medium that stores a computer-readable program code (e.g., software or firmware) executable by the (micro) processor, a logic gate, a switch, an application specific integrated circuit (ASIC), a programmable logic controller, an embedded microcontroller, or the like.

It will also be appreciated that any module, unit, component, server, computer, terminal or device exemplified herein that executes instructions may include or otherwise have access to computer-readable media such as storage media, computer storage media, or data storage devices (removable and/or non-removable) such as, for example, magnetic disks, optical disks or tape. The computer storage medium may include volatile and non-volatile, removable and non-removable media implemented in any method or technology for storage of information, such as computer-readable instructions, data structures, program modules, or the like.

The foregoing may be better understood in light of the following clauses:

Clause A1. A method for positioning an empty container, including: acquiring worker positioning information and a storage area image of loading containers; identifying an empty container attribute set in the storage area image; determining, based on the storage area image, a container classification label corresponding to each loading container and container position information corresponding to each loading container; and determining a target empty container based on the empty container attribute set, the container classification label corresponding to each loading container, the container position information corresponding to each loading container and the worker positioning information.

Clause A2. The method for positioning an empty container of clause A1, wherein determining the target empty container based on the empty container attribute set, the container classification label corresponding to each loading container, the container position information corresponding to each loading container and the worker positioning information includes: determining each candidate empty container based on the empty container attribute set and the container classification label corresponding to each loading container; determining a candidate container position corresponding to each candidate empty container based on the container position information corresponding to each loading container; and determining the target empty container based on the candidate container position corresponding to each candidate empty container and the worker positioning information.

Clause A3. The method for positioning an empty container of clause A2, wherein determining each candidate empty container based on the empty container attribute set and the container classification label corresponding to each loading container includes: if the container classification label of a current loading container matches an empty container attribute element in the empty container attribute set, determining that the current loading container is the candidate empty container.

Clause A4. The method for positioning an empty container of clause A2, wherein determining the target empty container based on the candidate container position corresponding to each candidate empty container and the worker positioning information includes: determining, based on the candidate container position corresponding to each candidate empty container and the worker positioning information, each movement trajectory between a worker and each candidate empty container and determining the target empty container based on a moving distance of each movement trajectory.

Clause A5. The method for positioning an empty container of clause A1, wherein identifying the empty container attribute set in the storage area image includes:
identifying an empty container attribute set in the storage area image by an attribute identification model.

Clause A6. The method for positioning an empty container of clause A5, wherein the attribute identification model includes a backbone identification network and an attribute classifier, wherein identifying the empty container attribute set in the storage area image by the attribute identification model includes: performing feature extraction on the storage area image through the backbone identification network to obtain loading container attribute features; and performing feature classification on the loading container attribute features through the attribute classifier to obtain the empty container attribute set.

Clause A7. The method for positioning an empty container of clause A1, wherein determining the container classification label corresponding to each loading container and container position information corresponding to each loading container based on the storage area image includes: determining a container classification label corresponding to each loading container and container position information corresponding to each loading container by a container detection model.

Clause A8. The method for positioning an empty container of clause A4, wherein after determining the target empty container based on the empty container attribute set, the container classification label corresponding to each loading container, the container position information corresponding to each loading container and the worker positioning information, the method further includes: sending the container position information of the target empty container and a movement trajectory corresponding to the target empty container to a worker task terminal.

Clause A9. A device for positioning an empty container, including: a memory; and at least one processor configured to: acquire worker positioning information and a storage area image of loading containers; identify an empty container attribute set in the storage area image; determine, based on the storage area image, a container classification label corresponding to each loading container and container position information corresponding to each loading container; and determine a target empty container based on the empty container attribute set, the container classification label corresponding to each loading container, the container position information corresponding to each loading container and the worker positioning information.

Clause A10. A non-transitory machine-readable medium having a program code for positioning an empty container stored thereon which, when executed by at least one processor, directs the at least one processor to perform the operations of: acquiring worker positioning information and a storage area image of loading containers; identifying an empty container attribute set in the storage area image; determine, based on the storage area image, a container classification label corresponding to each loading container and container position information corresponding to each loading container; and determining a target empty container based on the empty container attribute set, the container classification label corresponding to each loading container, the container position information corresponding to each loading container and the worker positioning information.

What is claimed is:

1. A method for positioning an empty container, the method comprising:
acquiring worker positioning information and a storage area image of loading containers;
identifying an empty container attribute set in the storage area image;
determining, based on the storage area image, a container classification label corresponding to each loading container and container position information corresponding to each loading container; and
determining a target empty container based on the empty container attribute set, the container classification label corresponding to each loading container, the container position information corresponding to each loading container and the worker positioning information.

2. The method of claim 1, wherein the determining of the target empty container comprises:
determining each candidate empty container based on the empty container attribute set and the container classification label corresponding to each loading container;
determining a candidate container position corresponding to each candidate empty container based on the container position information corresponding to each loading container; and
determining the target empty container based on the candidate container position corresponding to each candidate empty container and the worker positioning information.

3. The method of claim 2, wherein the determining of each candidate empty container comprises:
if the container classification label of a current loading container matches an empty container attribute element in the empty container attribute set, determining that the current loading container is the candidate empty container.

4. The method of claim 2, wherein the determining of the target empty container based on the candidate container position corresponding to each candidate empty container and the worker positioning information comprises:
determining, based on the candidate container position corresponding to each candidate empty container and the worker positioning information, each movement trajectory between a worker and each candidate empty container and
determining the target empty container based on a moving distance of each movement trajectory.

5. The method of claim 1, wherein the identifying of the empty container attribute set in the storage area image comprises:
identifying the empty container attribute set in the storage area image by an attribute identification model.

6. The method of claim 5, wherein the attribute identification model includes a backbone identification network and an attribute classifier,
wherein the identifying of the empty container attribute set in the storage area image by the attribute identification model comprises:
performing feature extraction on the storage area image through the backbone identification network to obtain loading container attribute features; and
performing feature classification on the loading container attribute features through the attribute classifier to obtain the empty container attribute set.

7. The method of claim 1, wherein the determining of the container classification label corresponding to each loading container and container position information corresponding to each loading container based on the storage area image comprises:
determining the container classification label corresponding to each loading container and container position information corresponding to each loading container by a container detection model.

8. The method for positioning an empty container of claim 4, further comprising:
after determining the target empty container based on the empty container attribute set, the container classification label corresponding to each loading container, the container position information corresponding to each loading container and the worker positioning information, sending the container position information of the target empty container and a movement trajectory corresponding to the target empty container to a worker task terminal.

9. A device for positioning an empty container, comprising:
a memory; and
at least one processor configured to:
acquire worker positioning information and a storage area image of loading containers;
identify an empty container attribute set in the storage area image;
determine, based on the storage area image, a container classification label corresponding to each loading container and container position information corresponding to each loading container; and
determine a target empty container based on the empty container attribute set, the container classification label corresponding to each loading container, the container position information corresponding to each loading container and the worker positioning information.

10. The device of claim 9, wherein the at least one processor is further configured to determine the target empty container based on the empty container attribute set, the container classification label corresponding to each loading container, the container position information corresponding to each loading container and the worker positioning information by:
determining each candidate empty container based on the empty container attribute set and the container classification label corresponding to each loading container;
determining a candidate container position corresponding to each candidate empty container based on the container position information corresponding to each loading container; and
determining the target empty container based on the candidate container position corresponding to each candidate empty container and the worker positioning information.

11. The device of claim 10, wherein the at least one processor is further configured to determine each candidate empty container based on the empty container attribute set and the container classification label corresponding to each loading container by:
if the container classification label of a current loading container matches an empty container attribute element in the empty container attribute set, determining that the current loading container is the candidate empty container.

12. The device of claim 10, wherein the at least one processor is further configured to determine the target empty container based on the candidate container position corresponding to each candidate empty container and the worker positioning information by:
determining, based on the candidate container position corresponding to each candidate empty container and the worker positioning information, each movement trajectory between a worker and each candidate empty container; and
determining the target empty container based on a moving distance of each movement trajectory.

13. The device of claim 9, wherein the at least one processor is further configured to identify the empty container attribute set in the storage area image by:
identifying an empty container attribute set in the storage area image by an attribute identification model.

14. The device of claim 13, wherein the attribute identification model includes a backbone identification network and an attribute classifier, wherein the at least one processor is further configured to identify the empty container attribute set in the storage area image by the attribute identification model by:
performing feature extraction on the storage area image through the backbone identification network to obtain loading container attribute features; and
performing feature classification on the loading container attribute features through the attribute classifier to obtain the empty container attribute set.

15. The device of claim 9, wherein the at least one processor is further configured to determine the container classification label corresponding to each loading container and container position information corresponding to each loading container based on the storage area image by:
determining a container classification label corresponding to each loading container and container position information corresponding to each loading container by a container detection model.

16. The device of claim 12, wherein the at least one processor is further configured to, after determining the target empty container based on the empty container attribute set, the container classification label corresponding to each loading container, the container position information corresponding to each loading container and the worker positioning information, send the container position information of the target empty container and a movement trajectory corresponding to the target empty container to a worker task terminal.

17. A non-transitory machine-readable medium having a program code for positioning an empty container stored thereon which, when executed by at least one processor, directs the at least one processor to perform the operations of:
acquiring worker positioning information and a storage area image of loading containers;
identifying an empty container attribute set in the storage area image;
determining, based on the storage area image, a container classification label corresponding to each loading container and container position information corresponding to each loading container; and
determining a target empty container based on the empty container attribute set, the container classification label corresponding to each loading container, the container position information corresponding to each loading container and the worker positioning information.
